(19) United States
(12) Patent Application Publication
(10) Pub. No.: US 2014/0380178 A1
(43) Pub. Date: Dec. 25, 2014

(54) DISPLAYING INTERACTIVE CHARTS ON DEVICES WITH LIMITED RESOURCES

(71) Applicant: Oracle International Corporation, Redwood Shores, CA (US)

(72) Inventor: Puneet Kapahi, New Delhi (IN)

(73) Assignee: Oracle International Corporation, Redwood Shores, CA (US)

(21) Appl. No.: 14/097,262

(22) Filed: Dec. 5, 2013

(30) Foreign Application Priority Data
Jun. 24, 2013 (IN) 2760/CHE/2013

(51) Int. Cl. G06F 3/0488

(52) U.S. Cl. CPC G06F 3/0488
USPC 715/738

(57) ABSTRACT

A server provided according to an aspect of the present disclosure receives as input, data values to be displayed in the form of a chart. The server renders the chart based on the received data values and also generates a static image for the rendered chart. The server, in addition, creates an area map indicating the portions of the static image, which correspond to the respective data values, and are interactive. The static image and the area map are served to devices, which are able to display the chart for interaction, with minimal resources in view of the availability of the static image as well as the area map.

### PRIORITY CLAIM

The instant patent application is related to and claims priority from co-pending India Application entitled, “Displaying Interactive Charts On Devices With Limited Resources”, Application Number: 2760/CHE/2013, filed on: 24 Jun. 2013, First Named Inventor: Puneet Kapahi, which is incorporated in its entirety herewith.

### RELATED APPLICATIONS

The instant patent application is related to the subject matter of the following patent applications, which are all herewith incorporated in their entirety to the extent not inconsistent with the disclosure of the instant patent application:

1. entitled, “Displaying Tooltips To Users Of Touch Screens”, Application Number: UNNASSIGNED, filed on: HEREWITH, First Named Inventor: Puneet Kapahi;

2. entitled, “Supporting Navigation On Touch Screens Displaying Elements Organized In A Fixed Number Of Dimensions”, Application Number: UNNASSIGNED, filed on: HEREWITH, First Named Inventor: Puneet Kapahi;

3. entitled, “Facilitating Touch Screen Users To Select Elements In A Densely Populated Display”, Application Number: UNNASSIGNED, filed on: HEREWITH, First Named Inventor: Puneet Kapahi; and

4. entitled, “Facilitating Touch Screen Users To Select Elements Identified In A Two Dimensional Space”, Application Number: UNNASSIGNED, filed on: HEREWITH, First Named Inventor: Puneet Kapahi.

### BACKGROUND OF THE DISCLOSURE

1. Technical Field

The present disclosure relates to user interfaces on digital processing systems, and more specifically to displaying interactive charts on devices with limited resources.

2. Related Art

A chart refers to graphical display of information. The data values underlying the information are visually represented in some related form, such that appropriate information can be easily gleaned. Each data value may be represented in the form of a corresponding element in the graphical display.

A chart is interactive when the user can select specific desired element, typically for the purpose of additional information. Adobe™ Flash type technologies provide for interactive features in browsers, but may be unsuitable in mobile phone type devices, which are characterized by limited resources (i.e., small memory or slow processor, etc.).

### BRIEF DESCRIPTION OF THE DRAWINGS

Example embodiments of the present disclosure will be described with reference to the accompanying drawings briefly described below.

FIG. 1 is a block diagram illustrating an example computing system in which several aspects of the present disclosure can be implemented.

FIG. 2 is a flow chart illustrating the manner in which a touch screen based system permits selection of desired elements in an embodiment.

FIGS. 3A-3K represent respective displays on a touch screen illustrating the selection and display of tooltip information

FIG. 4 is a block diagram illustrating the details of a server system in an embodiment.

FIG. 5 is a block diagram illustrating the details of a digital processing system in which various aspects of the present disclosure are operative by execution of appropriate software instructions.

FIG. 6A depicts portion of sample HTML text sent to a touch system.

FIG. 6B is a map logically depicting the various interactivity features enabled for specific data elements, in an embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

A server provided according to an aspect of the present disclosure receives as input, data values to be displayed in the form of a chart. The server renders the chart based on the received data values and also generates a static image for the rendered chart. The server, in addition, creates an area map indicating the portions of the static image, which correspond to the respective data values, and are interactive. The static image and the area map are served to devices, which are able to display the chart for interaction, with minimal resources in view of the availability of the static image as well as the area map.

According to another aspect of the present disclosure, the server provides for various types of interactivity at the devices. In an embodiment, the user is provided the ability to exercise any of several available interactive options upon one type of touch (e.g., continued touch for an extended duration) associated with a displayed element, or seek additional detail (“drill down” capability) of the specific data value upon another type of touch (quick tap) associated with the data value. In appropriate circumstances, the user may be provided the ability to simply navigate to a specific web page.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

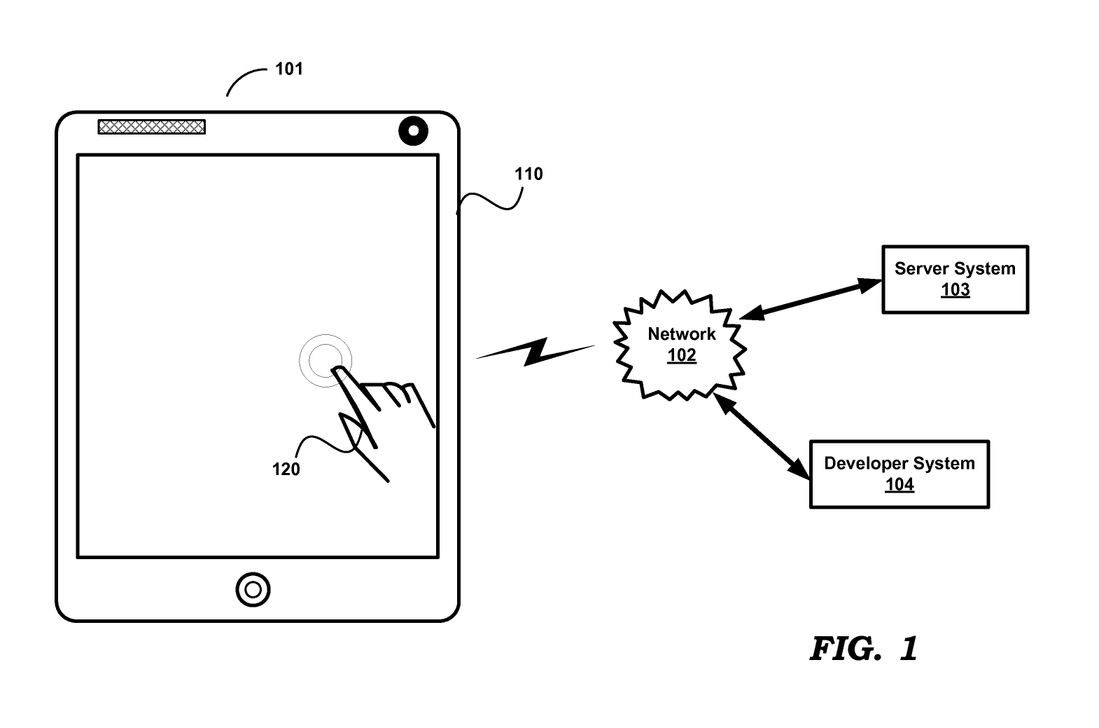

FIG. 1 is a block diagram illustrating the details of an example environment in which several features of the present disclosure can be implemented. The environment is shown containing touch system 101, server system 103, developer system 104, all connected via network 102. Each block is described below in further detail.

Network 102 provides connectivity between touch system 101 and server system 103. Merely for illustration, touch system is shown communicating over wireless path, and server system 103 using a wire-based path. However, each system 101/103/104 can have the ability to communicate based on wireless and/or wire-based paths.

Touch system 101 is an example system with limited resources, and provides user interfaces based on touch screens. Touch system 101 may implement client side complementing the server side implementation on server system 103. The networked applications can be as simple as a web browser (with appropriate plug-ins) or a custom application such as a mobile application. Touch system 101 may for example correspond to a personal digital assistant (PDA), a mobile phone, etc. A user is shown performing a touch operation on touch screen 110 using finger 120. As noted above, touch operations can be performed using one or more fingers, stylus, etc.

Touch screen 110 is used for displaying various elements. An element is represented by a portion of a display, visually identifiable as a separate entity in its display context. Examples of elements include various graphical icons, interface elements (buttons, scrollbars, etc.), etc, normally generated by the operation of various user applications (e.g., word processors, spread sheets, custom business applications, etc.) or shared utilities (e.g., operating system).

Developer system 104 represents a digital processing system, which provides digital values, which form the basis for the content of various charts displayed on touch system 101. Developer system 104 may also specify the type of graph using which the data values are to be graphically represented.

Server system 103 implements various applications, that form the basis for interaction with touch system 101. Server system 103, provided according to an aspect of the present disclosure, sends pages in a form suitable for display on touch screen 110. The data elements forming the basis for such a display may be generated by applications executing on server system 103, though described as being received from developer system 104. The operation of server system 103 is described below with examples.

### 3. Sending Interactive Charts

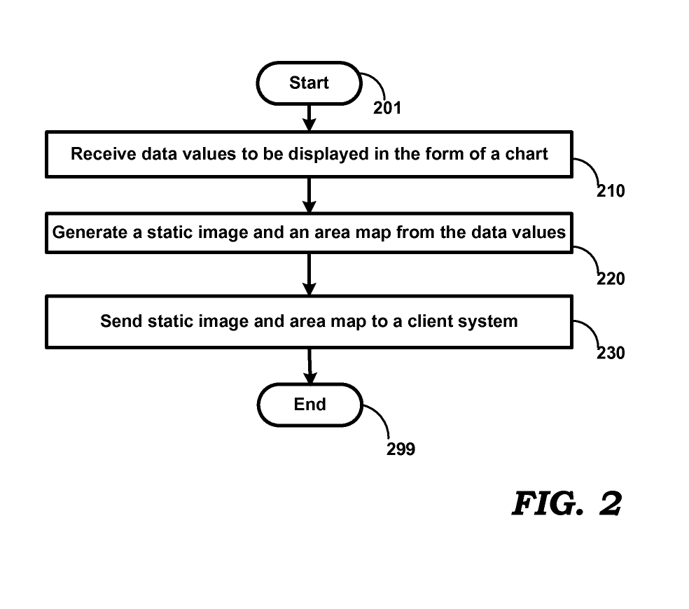

FIG. 2 is flowchart illustrating the manner in which interactive charts are provided to touch systems, in an embodiment of the present disclosure. The steps in the flowchart are described with respect to the example system of FIG. 1, and in a specific sequence merely for illustration. Alternative embodiments in other devices/environments, and using a different sequence of steps can also be implemented without departing from the scope and spirit of several aspects of the present disclosure, as will be apparent to one skilled in the relevant arts by reading the disclosure provided herein. The flowchart starts in step 201, in which control passes immediately to step 210.

In step 210, server system 103 receives from developer system 104 (over network 102) data values to be displayed in the form of a chart. The data values can represent any information, as suitable in the corresponding environments. While the data values are described as being received from developer system 104, it may be appreciated that the values may be generated internally within server system 103 by execution of appropriate user applications.

In step 220, server system 103 generates a static/raster image and an area map from the received data values. The static image represents the chart containing visual elements corresponding to the data values. Normally, each visual element in some form represents the attributes (e.g., magnitude) of each data value. The area map indicates numerically interactive portions of the static image (or specifically, the part of the visual element) for interacting with the corresponding visual elements. For example, assuming the chart is logically mapped to a two dimensional coordinate plane, the specific interactive portion for each visual element may be indicated by the area map.

In step 230, server system 103 sends for display on a client device, the generated static image and the area map.

Because of the availability of the bit map, touch system 103 may be able to generate the display of the elements in the chart, without substantial processing requirements (e.g., to render the image based on complex model information of various elements). Since the area map identifying the specific interactive portions is also provided, the chart is made interactive. Server system 103 may be able to easily generate both the static map and area map, since both are being generated within server system

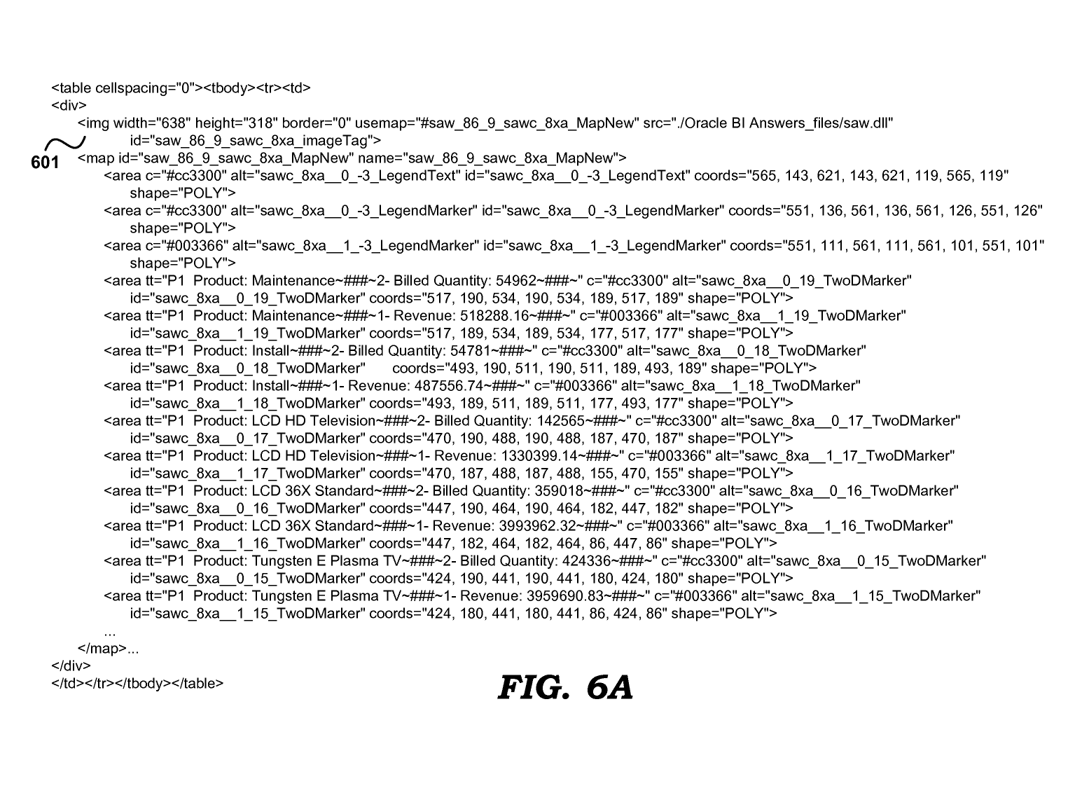

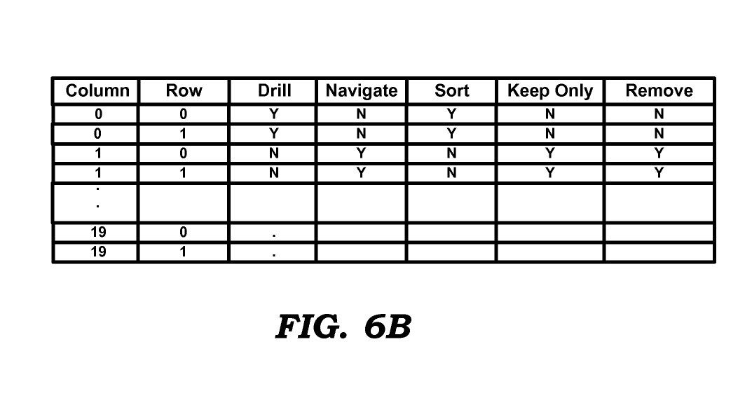

FIG. 6A depicts example format in which the static image and area map are sent to a client system in an embodiment. Portion 601 represents the raster image (using <img> HTML tag) sent for display. The raster image is indicated as having associated area map, the details of which are shown in the data contained in the body of <map> HTML tag. Each of the <area> tags represents a corresponding interactive element. The tooltip, if present, corresponding to each element is shown as the value of the respective attribute ‘tt’ of the <area> tag.

The above noted approaches and some other features of the present disclosure are illustrated below with respect to various examples.

### 4. Examples

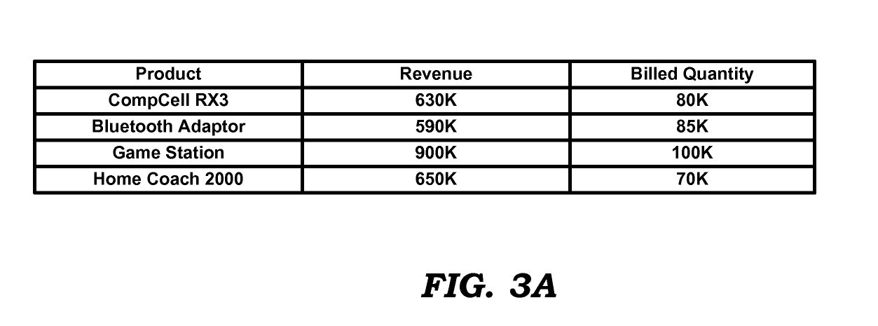

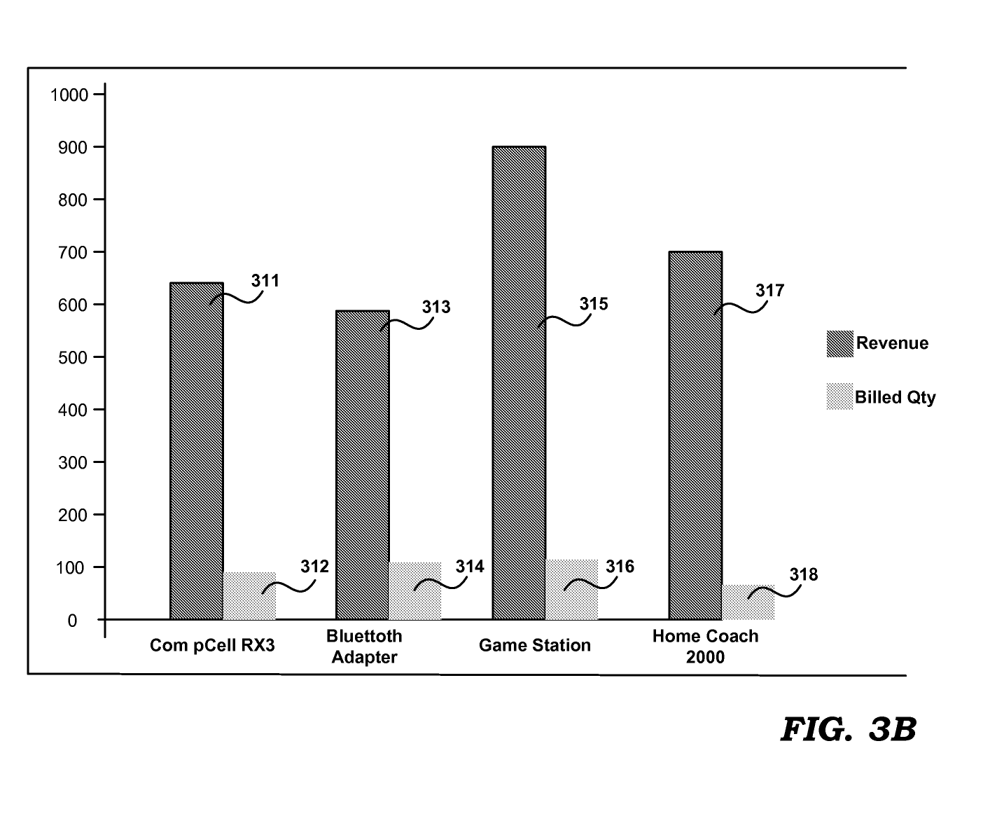

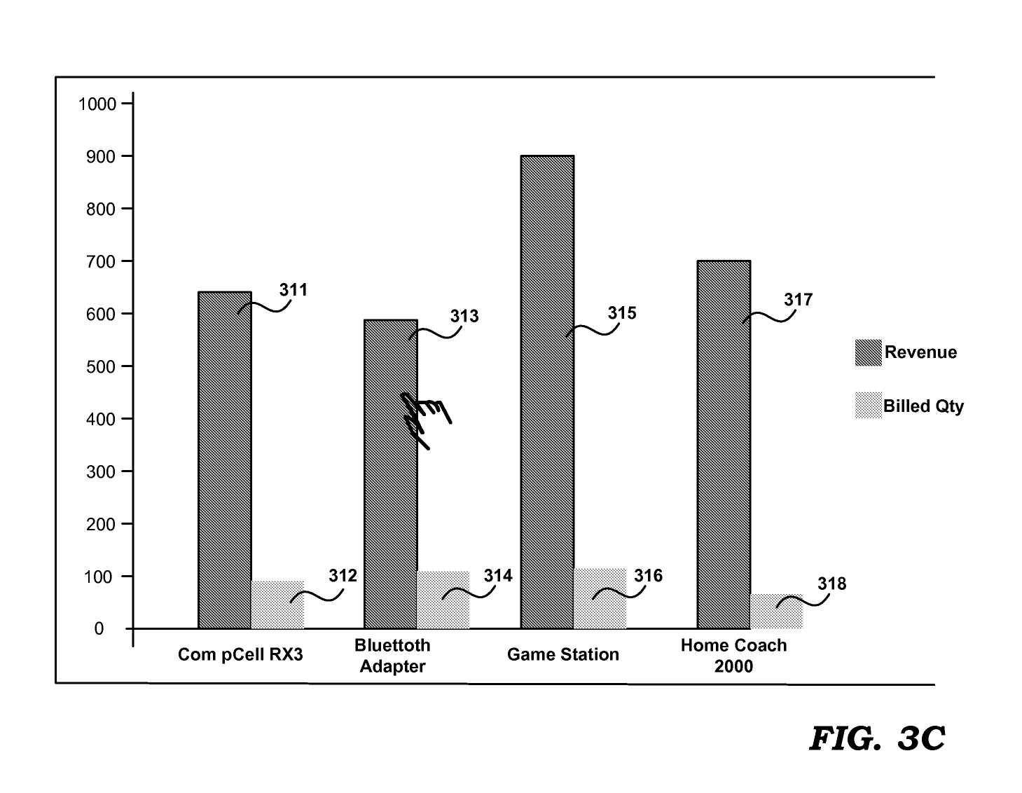

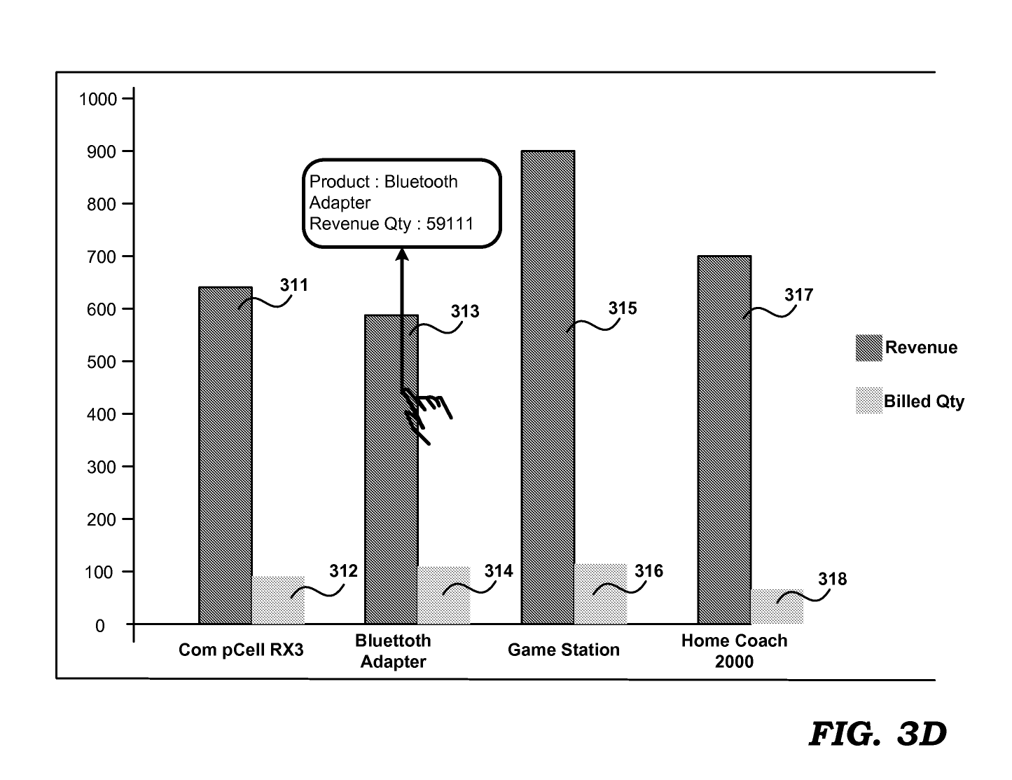

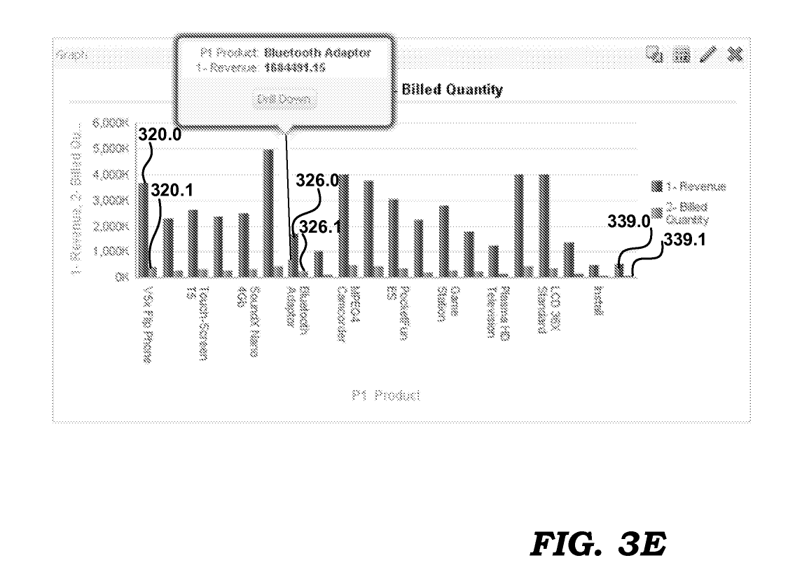

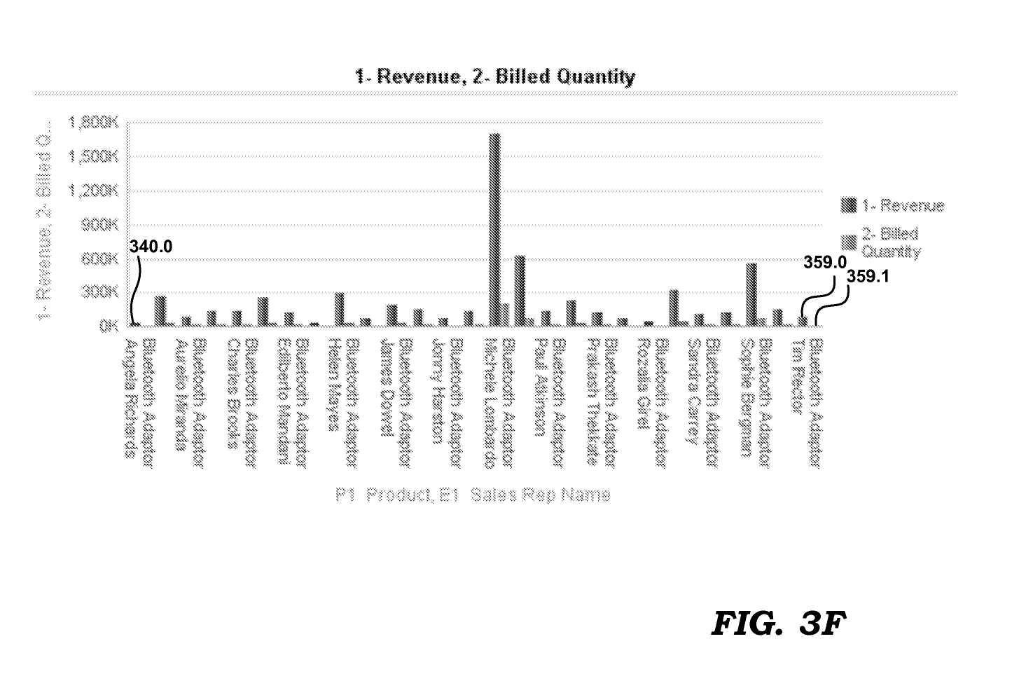

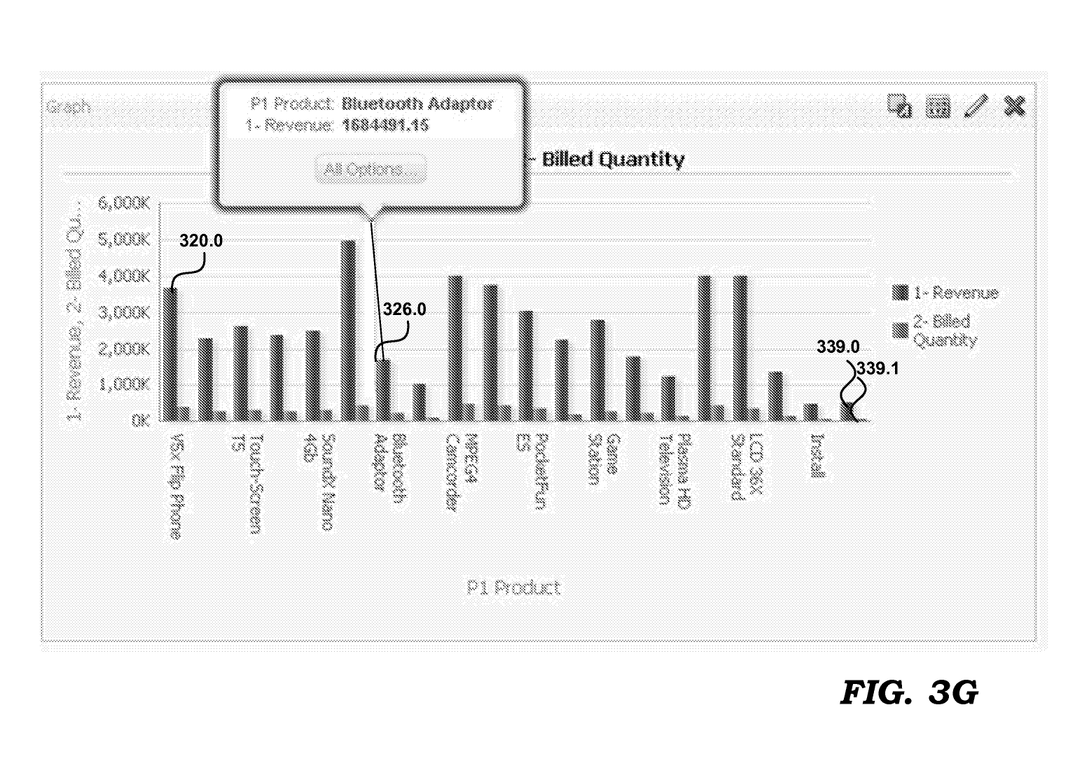

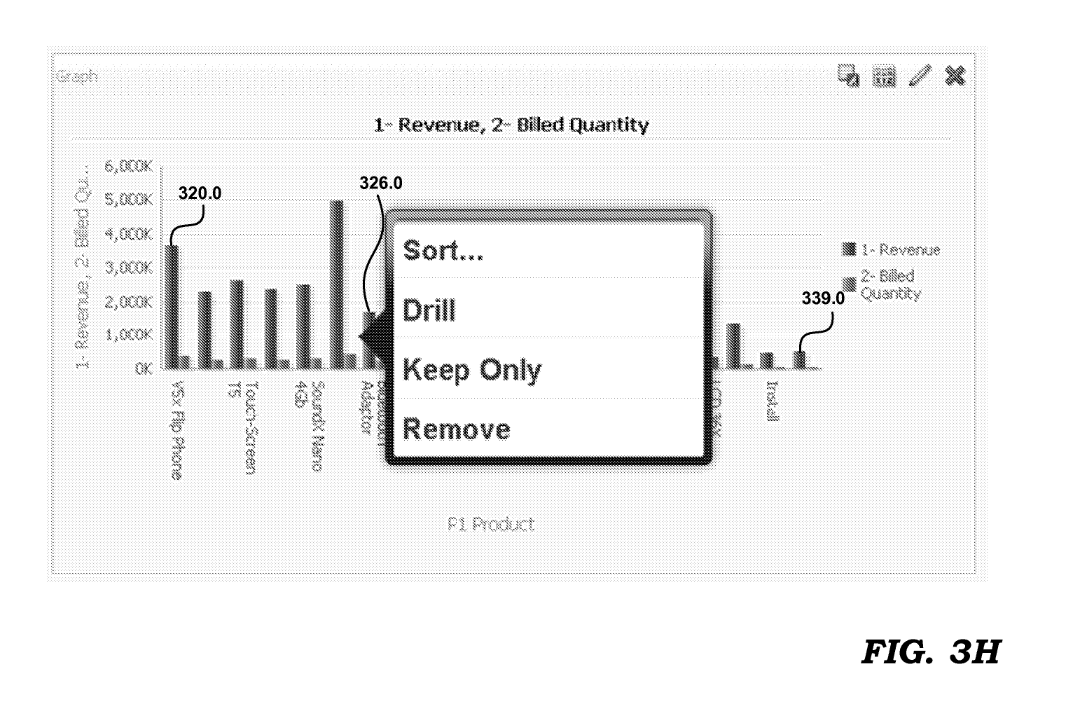

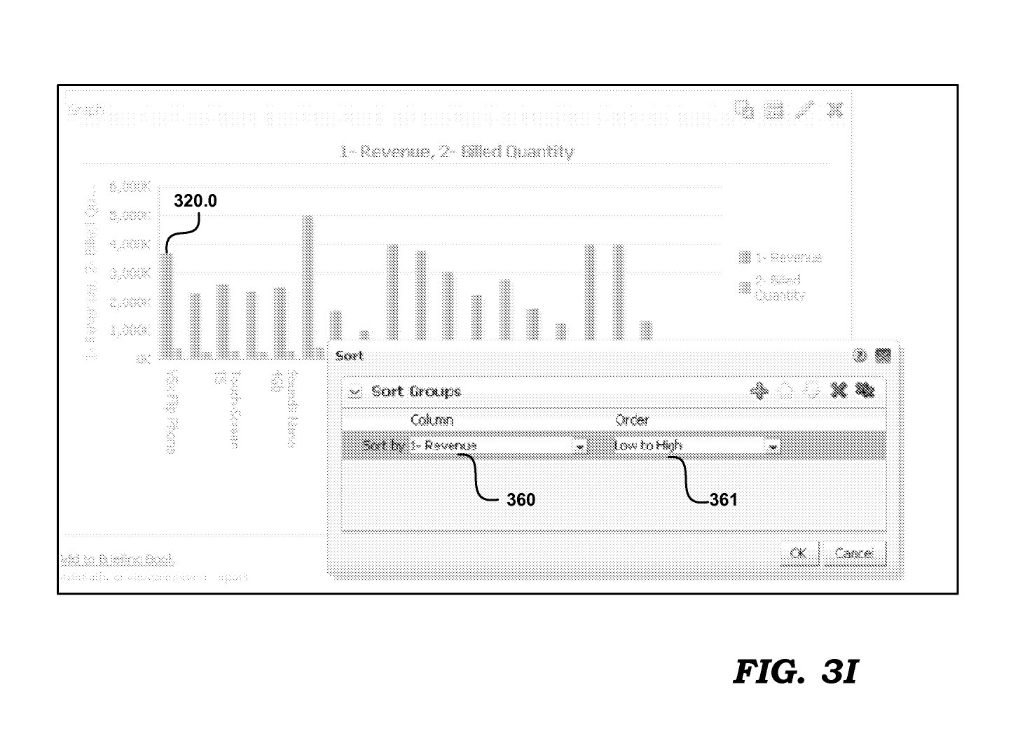

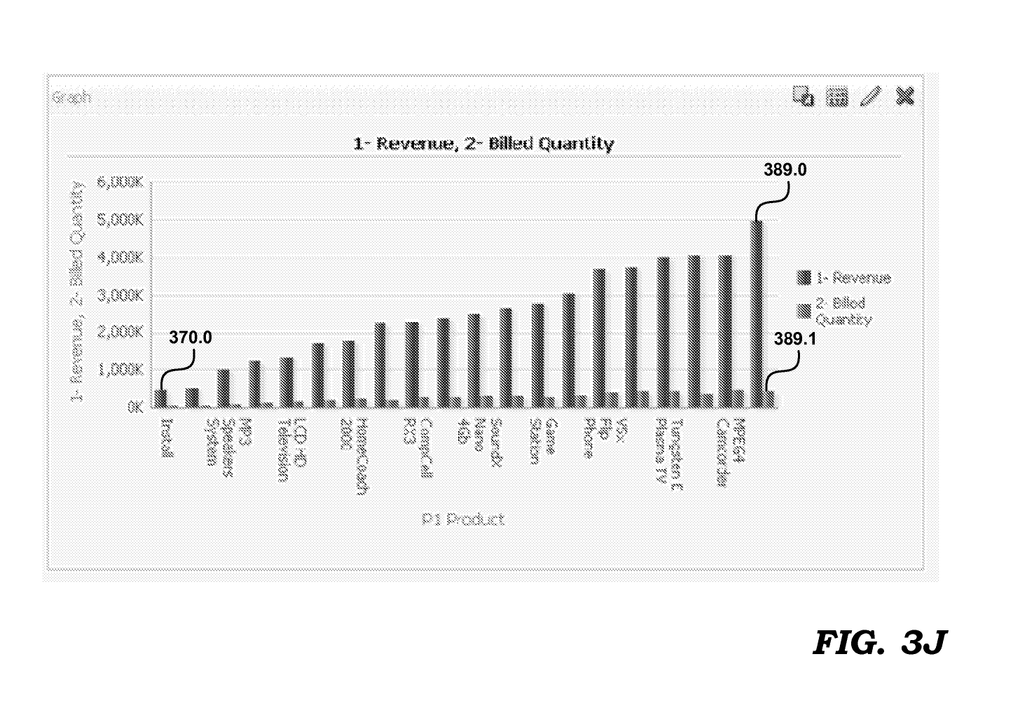

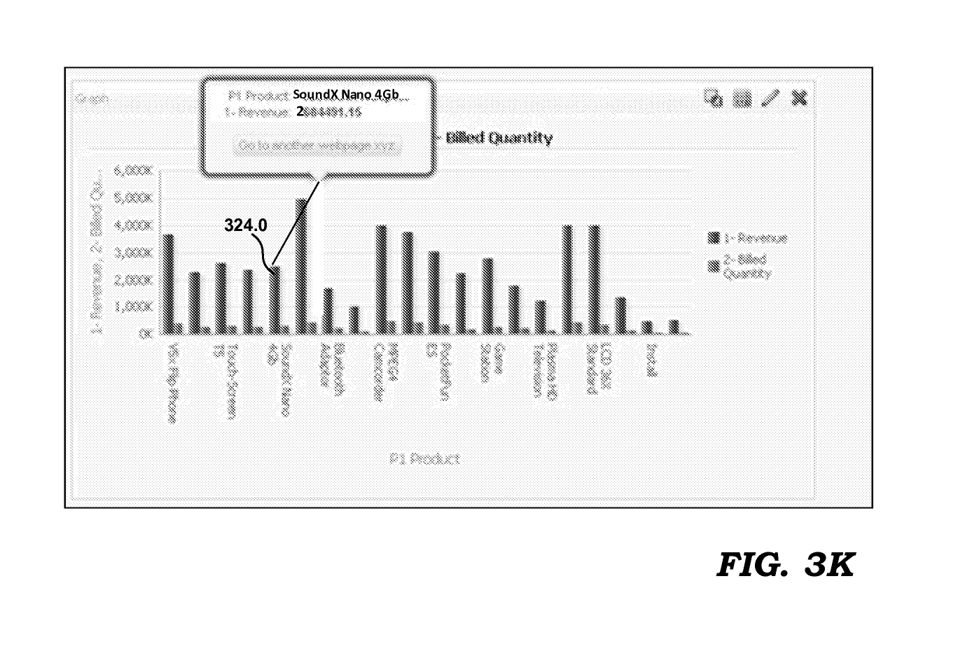

FIG. 3A depicts example data elements received from developer system 104. It is assumed that the data elements are received associated with a request to generate a ‘stacked-bar’ graph in the chart. Various types of other graphs (e.g., pie chart) can also be similarly requested with correspondingly appropriate data points.

Server system 103 generates the static image map and the area map. The static map (bit map or raster image) may be in formats such as PNG (Portable Network Graphics) such that each point of the static image is represented by a corresponding color code (e.g., in RGB or YUV format). The static image may be generated for the entire chart or for the (visual) elements. Irrespective, while generating the static image map, the areas covered by the elements representing each data value is tracked, for inclusion as the area map.

FIG. 3B depicts a display generated on touch screen 110 from the static map generated. The display may be generated by a browser software (e.g., Internet Explorer Version 10.0) processing the web page received from server system 103. As may be readily observed, 8 elements 311-318 are shown displayed (assuming the text of product code is not considered as a data value) corresponding to eight data values.

Each element is shown covering several pixels of the touch screen. Assuming that any part of the entire area displaying an element can be selected, the entire display portion corresponding to each element is included as the corresponding interactive portion (for the element) in the area map. Thus, the area map for each element may specify the interactive portion in vector form (contrasted with raster form), i.e., indicating the shape, size and position information.

The area map in addition specifies the action to be performed upon selection of the element. For illustration, it is assumed that a tool tip is displayed associated with an element upon selection of the element (based on the area map), in view of the ‘tt’ attribute for the corresponding element. The area map is thereafter used, for example, to select an element and seek related information as a tooltip, as illustrated with respect to FIGS. 3C and 3D below.

FIG. 3C depicts that a user has tapped/touched on the interactive area defined (in the area map) for one of the elements 313. Assuming the area map has indicated that the touched area (point) is interactive with respect to the corresponding element, the touched element is shown selected by displaying the corresponding tooltip in FIG. 3D. The user may select other elements (for example, by touching the corresponding interactive portions specified in the area map) and seek the corresponding tooltip information.

Aspects of the present disclosure can provide more extensive interactivity features also, as described below with additional examples. These features can be provided at touch system 101 in combination with respective features described in the related applications noted above, as well.

FIGS. 3E and 3F together depict the manner in which user may seek more detailed information on a displayed element. In particular, for the data value corresponding to the element, the more detailed information forming the basis for the data value is shown as ‘drill down’ information.

FIG. 3E depicts the display after a user has tapped (touched briefly) element 326.0 (Revenue for Bluetooth Adapter). There are shown on the X-axis, 20 entities (having respective one of the prefixes 320-339), with each entity having a revenue data (suffixed by 0) and billed quantity (suffixed by 1). The tooltip box (after selection of element 326.0) is shown containing a ‘Drill Down’ button.

Upon the user clicking/tapping on the button, a corresponding request is sent to server system 103, which then sends a web page that causes the display of FIG. 3F. As may be appreciated, the X-axis has the corresponding sales representatives (340-359), and their respective revenues (suffix 0) and billed quantities (suffix of 1) along the Y-axis. It should be appreciated that the user can similarly tap on (or select otherwise) other data elements for the Drill Down option (if such option is provided by server system 103),

FIG. 3G depicts the display after a long-press/touch (i.e., continued touch for a substantial duration, say more than 2 seconds) again on element 326.0. The tool tip now is shown with ‘All Options’ button in FIG. 3H. Upon a user selecting (by tapping) the button, a new tooltip is shown with 4 options—Sort, Drill (corresponding to FIG. 3E), Keep Only and Remove. The Sort option is described below. The ‘Keep Only’ option causes the remaining elements to be removed from the displayed graph, while the ‘Remove’ option causes just the selected data element to be removed from the displayed graph.

The display of FIG. 3I is generated upon the user selecting the Sort option. FIG. 3I shows a pop-up, in which the user can select the column on which to sort the data, and the order of sort. Assuming the displayed options to be selected and upon the user selecting OK button, the display of FIG. 3J is generated on touch system 101. As may be seen there, the elements are sorted in ascending order (low to high) of Revenue.

Thus, the drill-down detail is described as being the default option on a simple touch, while ‘All Options’ are displayed upon long-press. However, ‘All Options’ can be displayed as the default option on a simple touch, etc., in alternative embodiments, as will be apparent to a skilled practitioner by reading the disclosure provided herein.

FIG. 3K depicts another interactivity option as a default option on a simple touch. As shown there, the user is shown having selected element 324.0 by a simple touch, and navigation option to another web page is shown by a button in the tooltip box. Upon the user selecting, the web page corresponding to ‘webpage xyz’ is retrieved from server system 103 and displayed on touch system 101.

The description is continued with respect to the manner in which server system 103 can be implemented in several embodiments.

### 5. Server System

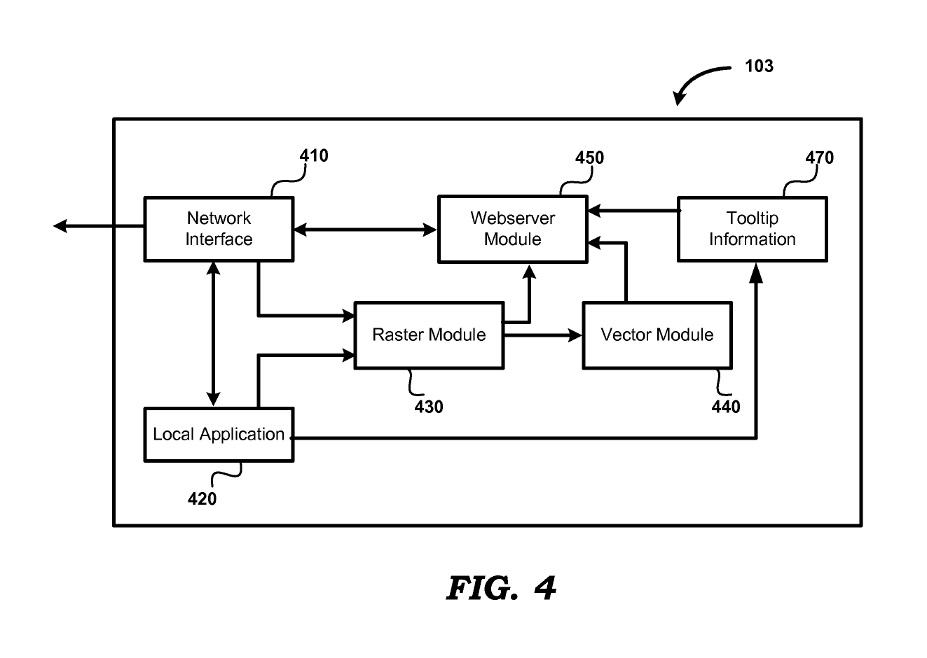

FIG. 4 is a block diagram illustrating the details of server system 103 in an embodiment. Server system 103 is shown containing network interface 410, local application 420, raster module 430, vector module 440, web server module 450, and tooltip information 470.

Network interface 410 provides the connectivity with touch system 103 and developer system 104. The data values of FIG. 3A (and the graph type) may be received via network interface 410, and provided to raster module 430. The web page constructed by web server module 450 is sent via network interface 410.

Local application 420 may correspond to any user application (e.g., ERP application) which generates data values (and the graph type of interest) for display in accordance with the present disclosure. The data values may be provided to raster module 430, with an indication of desired graph type. The data values may represent any information for the entities of interest, though revenue and billed values are shown above for illustration.

Raster module 430 generates the raster image (bit map of FIG. 3B) of the chart based on the received data values (e.g., FIG. 3A) and the requested graph type (e.g., stacked bar). The raster image is provided to web server module 450, while indicating the location/shape and size of each visual element to vector module 440.

Vector module 440 forms the area map indicating the interactive portion corresponding to each visual element in the raster image. Tooltip information 470 contains the corresponding information associated with each of the visual element. The information may be received from the source (i.e, local application 420 or developer system 104) generating the data values, or can be any other information (e.g., based on user configuration).

Web server module 450 forms a web page according to conventions such as HTML, and is sent via network interface 410 for display on touch system 101. The web page contains the raster image, the area map and tool tip information (associated with the individual visual elements identified by the area map). The web page may contain additional content also, which provides for the interactivity features described above, as is described below in further detail.

### 6. Interactivity Features

In an embodiment of the present disclosure, the web page sent to touch system 101 may be viewed as containing three components—(1) HTML text depicting the layout of various elements as a part of the graph to be displayed on touch screen; (2) map indicating the interactivity features enabled for each displayed element; and (3) Client-side script (e.g., as JavaScript) which uses the HTML text and the map to coordinate the interactivity features. Each component is described below in further detail.

With respect to component (1) of above, a portion of the HTML text (corresponding at least substantially to the display in FIGS. 3E-3K) is shown in FIG. 6A. As noted above, the raster image (provided by raster module 430) is indicated using the <img> HTML tag, while the various interactive portions (provided by vector module 440) are indicated using the <area> HTML tag. In addition, ‘tt’ is a custom HTML tag used for identifying the tooltip text for the corresponding element.

It may be observed that each of the interactive portions/areas is associated with a unique identifier (as specified by the value of the “id” attributed). The unique identifier (e.g., “sawc_{—}8xa_{—}1_{—}18_TwoDMarker”) is formed (by local application 420) by concatenating the name of the graph (“sawc_{—}8xa”), the row slice number (0 or 1), the column slice number (18) and a marker type (“TwoDMarker”). The row and column slice numbers may be used to uniquely identify the data point corresponding to the interactive portion. The marker type may be used to indicate to the client, the specific manner in which the interactive portion is to be displayed. The marker type may be one of bar, point, pie slice, 2d marker, legend, etc.

With respect to component (2) of above, a representative portion of the map is shown in FIG. 6B. The information in the map may be encoded according to JSON (JavaScript Object Notation), well known in the relevant arts. As may be readily appreciated, Row and Column values uniquely identify each element (with one to one correspondence to values in id attribute of area in FIG. 6A).

The specific interactivity features enabled for each element is shown in the corresponding row. The features shown with entry ‘Y’ are included for ‘All Options’ of FIGS. 3G/3H described above. Additional columns may be present, for example, to indicate the web page URL for the Navigate feature.

With respect to component (3) of above, the JavaScript program is encoded with the requisite local functionality, complementing the general functions provided by browser type software, which displays the web page on touch system 101. Thus, when a user selects an element, the program identifies the corresponding TT attribute (of the selected element) and displays the information as a tooltip.

Upon user actions that can be processed locally (e.g., showing of the button/options/pop-ups of FIGS. 3E, 3G, 3H, 3I, 3K, etc.), the program causes the performance of the corresponding operations. The JSON object corresponding to information of FIG. 6B is examined, for causing the relevant displays. When server system 103 is required to be contacted for a next web page (e.g., for the detail of FIG. 3F, sorted output of FIG. 3J), the program constructs the appropriate URL (or other identifiers) and sends the URL to server system 103.

Webserver module 450, local application 420, etc., may accordingly be implemented to generate the web page content consistent with the above disclosure. Thus, when multiple data points form the basis for a data value displayed as an element, the drill-down option may be automatically made available for that element. Local application 420 may include all such available options, etc., as a part of tooltip information 470, which is then used by webserver module 450 in formulating the web pages. Some of the interactivity options may be driven by user configurations/inputs as well.

In addition, when requests are received (e.g., for drill down information as in FIG. 3E or sort request as in FIG. 3I), webserver module 450 may receive the request, and generate the response web page by interfacing with local application 420 (or the database, not shown, storing the base data directly). The generation of such responses may be performed in a known way.

As most modern web-browsers support JavaScript and as the overhead of calculation of the geometries and rendering is handled at the server systems, aspects of the present disclosure can be implemented (without limitation) on devices with limited resources supporting such web-browsers.

It should be further appreciated that the features described above can be implemented in various embodiments as a desired combination of one or more of hardware, software, and firmware. The description is continued with respect to an embodiment in which various features are operative when the software instructions described above are executed.

### 7. Digital Processing System

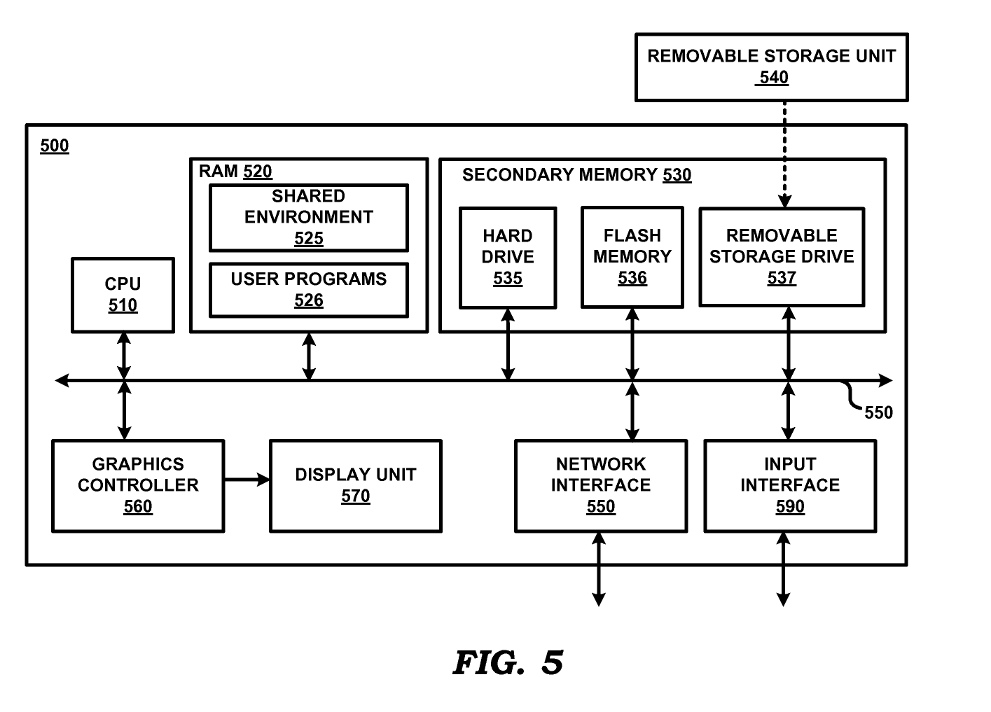

FIG. 5 is a block diagram illustrating the details of digital processing system 500 in which various aspects of the present disclosure are operative by execution of appropriate software instructions. Digital processing system 500 may correspond to server system 103. Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path (bus) 550, which may contain several buses as is well known in the relevant arts. The components of FIG. 5 are described below in further detail.

CPU 510 may execute instructions stored in RAM 520 to provide several features of the present disclosure. CPU 510 may contain multiple processors, with each processor potentially being designed for a specific task. Alternatively, CPU 510 may contain only a single general-purpose processor. Such combination of one or more processors may be referred to as a processing unit.

RAM 520 may receive instructions from secondary memory 530 using communication path 550. RAM 520 is shown currently containing software instructions constituting shared environment 525 and/or user programs 526 (such as RDBMS, Spread Sheet software, Word Processors, etc., representing the location application 420). The instructions may represent modules 430, 440 and 450 noted above, in addition. Shared environment 525 includes operating systems, device drivers, virtual machines, etc., which provide a (common) run time environment for execution of user programs 526.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse) and may be used to provide inputs. Network interface 550 provides connectivity to a network (e.g., using Internet Protocol), and may be used to communicate with other systems (such as those shown in FIG. 1) connected to the network.

Secondary memory 530 represents a non-transitory machine readable storage medium, and may store data (e.g., tooltip information 470) and software instructions (e.g., for performing the actions noted above with respect to FIGS. 2 and 3B-3E) which enables system 500 to provide several features in accordance with the present disclosure. The code/instructions stored in secondary memory 530 may either be copied to RAM 520 prior to execution by CPU 510 for higher execution speeds, or may be directly executed by CPU 510.

Secondary memory 530 may contain hard drive 535, flash memory 536, and removable storage drive 537. Some or all of the data and instructions may be provided on removable storage unit 540, and the data and instructions may be read and provided by removable storage drive 537 to CPU 510. Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 530. Volatile media includes dynamic memory, such as RAM 520. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 550. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 8. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of facilitating display of interactive charts on client devices with touch screens, said method being performed in a server system, said method comprising:
receiving a plurality of data values to be displayed in the form of a chart;
generating a static image and an area map from said plurality of data values, said static image representing said chart containing a plurality of visual elements corresponding to said plurality of data values, said area map indicating interactive portions of said static image for interacting with said visual elements; and
sending for display on a client device with a touch screen, said static image and said area map to enable said client device to display said chart for interaction with a desired visual element of said plurality of visual elements.

2. The method of claim 1, wherein said static image map is a raster image, wherein said raster image contains a plurality of portions, with each portion representing a corresponding visual element of said plurality of visual elements.

3. The method of claim 2, wherein said area map contains a plurality of vector sets, each vector set numerically indicating the a respective part of the corresponding visual element, which provides interactivity for a user, wherein a user touches on the respective part of the desired visual element on said touch screen to select the desired visual element.

4. The method of claim 3, wherein said sending further includes a respective tooltip for each visual element of said plurality of visual elements, wherein the tool tip corresponding to the desired element is displayed on said touch screen upon said user touching said part of the desired element indicated in said area map.

5. The method of claim 4, wherein said static image map and said area map are included in a web page sent to said client device,
wherein said web page further includes an activity map and a program script,
wherein said activity map indicates a corresponding interactivity features enabled for each visual element of said plurality of visual elements,
wherein said program script facilitates said user to access the corresponding interactivity features based on touch operations associated with each visual element.

6. The method of claim 5, wherein said interactivity features include drill down, sort, remove and keep only options associated with a first visual element of said plurality of visual elements.

7. The method of claim 5, wherein said plurality of data values are received from another system external to said server system, wherein said server system sends said static image, said vector sets and said tooltips encoded in a HTML page for display on said client device.

8. A non-transitory machine readable medium storing one or more sequences of instructions for causing a server system to facilitate display of interactive charts on client devices with touch screens, wherein execution of said one or more sequences of instructions by one or more processors contained in said server system causes said server system to perform the actions of:
receiving a plurality of data values to be displayed in the form of a chart;
generating a static image and an area map from said plurality of data values, said static image representing said chart containing a plurality of visual elements corresponding to said plurality of data values, said area map indicating interactive portions of said static image for interacting with said visual elements; and
sending for display on a client device with a touch screen, said static image and said area map to enable said client device to display said chart for interaction with a desired visual element of said plurality of visual elements.

9. The machine readable medium of claim 8, wherein said static image map is a raster image, wherein said raster image contains a plurality of portions, with each portion representing a corresponding visual element of said plurality of visual elements.

10. The machine readable medium of claim 9 wherein said area map contains a plurality of vector sets, each vector set numerically indicating the a respective part of the corresponding visual element, which provides interactivity for a user, wherein a user touches on the respective part of the desired visual element on said touch screen to select the desired visual element.

11. The machine readable medium of claim 10, wherein said sending further includes a respective tooltip for each visual element of said plurality of visual elements, wherein the tool tip corresponding to the desired element is displayed on said touch screen upon said user touching said part of the desired element indicated in said area map.

12. The machine readable medium of claim 11, wherein said static image map and said area map are included in a web page sent to said client device,
wherein said web page further includes an activity map and a program script,
wherein said activity map indicates a corresponding interactivity features enabled for each visual element of said plurality of visual elements,
wherein said program script facilitates said user to access the corresponding interactivity features based on touch operations associated with each visual element.

13. The machine readable medium of claim 12, wherein said interactivity features include drill down, sort, remove and keep only options associated with a first visual element of said plurality of visual elements.

14. The machine readable medium of claim 12, wherein said plurality of data values are received from another system external to said server system, wherein said server system sends said static image, said vector sets and said tooltips encoded in a HTML page for display on said client device.

15. A server system to facilitate display of interactive charts on client devices with touch screens, said server system comprising:
a memory to store instructions; and
a processing unit for retrieving and executing the retrieved instructions to cause said server system to perform the actions of:
generating a static image and an area map from said plurality of data values, said static image representing said chart containing a plurality of visual elements corresponding to said plurality of data values, said area map indicating interactive portions of said static image for interacting with said visual elements; and
sending for display on a client device with a touch screen, said static image and said area map to enable said client device to display said chart for interaction with a desired visual element of said plurality of visual elements.

16. The server system of claim 15, wherein said static image map is a raster image,
wherein said raster image contains a plurality of portions, with each portion representing a corresponding visual element of said plurality of visual elements.

17. The server system of claim 16 wherein said area map contains a plurality of vector sets, each vector set numerically indicating the a respective part of the corresponding visual element, which provides interactivity for a user, wherein a user touches on the respective part of the desired visual element on said touch screen to select the desired visual element.

18. The server system of claim 17, wherein said sending further includes a respective tooltip for each visual element of said plurality of visual elements, wherein the tool tip corresponding to the desired element is displayed on said touch screen upon said user touching said part of the desired element indicated in said area map.

19. The server system of claim 18, wherein said static image map and said area map are included in a web page sent to said client device,
wherein said web page further includes an activity map and a program script,
wherein said activity map indicates a corresponding interactivity features enabled for each visual element of said plurality of visual elements,
wherein said program script facilitates said user to access the corresponding interactivity features based on touch operations associated with each visual element.

20. The server system of claim 19, wherein said plurality of data values are received from another system external to said server system, wherein said server system sends said static image, said vector sets and said tooltips encoded in a HTML page for display on said client device.
